(19) United States
(12) Patent Application Publication
(10) Pub. No.: US 2009/0026947 A1
(43) Pub. Date: Jan. 29, 2009

(54) Method for Producing a Discharge Tube Arrangement, and One Such Discharge Tube Arrangement

(75) Inventors: Florian Bedynek, Berlin (DE); Franz Brenner, Zusmarshausen (DE); Jurgen Graf, Augsburg (DE); Thomas Schmidt-Lehmann, Kleinmachnow (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRICHE GLULAMPEN MBH, Munchen (DE)

(21) Appl. No.: 11/885,168

(22) PCT Filed: Feb. 7, 2006
(86) PCT No.: PCT/DE2006/000200

§ 371 Date: Mar. 17, 2008

(30) Foreign Application Priority Data
Feb. 28, 2005 (DE) 10 2005 009 609.3
Mar. 16, 2005 (DE) 10 2005 012 488.7

(51) Int. Cl. H01J 17/20; H01J 9/38; H01J 61/00

(52) U.S. Cl. 313/570; 445/38; 313/567

(57) ABSTRACT

A method for producing a discharge tube arrangement (1) for a lamp, and a discharge tube arrangement produced according to one such method. The arrangement has an outer piston (2) into which a discharge tube (6) is inserted, the outer piston being sealed to the discharge tube and defining a gas-tight intermediate region (12) therewith, for receiving a gas inflation (14). According to the invention, the intermediate region (12) is cleaned and/or filled with gas via the discharge tube (6).

### TECHNICAL FIELD

The invention relates to a method for producing a discharge tube arrangement in accordance with the precharacterizing clause of patent claim 1 and to a discharge tube arrangement in accordance with the precharacterizing clause of patent claim 17.

### PRIOR ART

In principle, the invention can be applied to all lamps in which a discharge tube is accommodated in an outer bulb or the like. However, the main application area should be in discharge lamps which are surrounded by an outer bulb which is connected in sealing fashion to the discharge tube via two outer bulb ends. Such a discharge tube arrangement and its production methods are known, for example, from DE 101 57 868 A1.

The production of this known discharge tube arrangement takes place by virtue of the fact that, first, a discharge tube is inserted into an outer bulb. This outer bulb has two outer bulb ends and is welded in sealing fashion to a flange area of the discharge tube after heating along a first outer bulb end. Then, a gas exchange takes place in the approximately annular intermediate space delimited by the discharge tube and the outer bulb via the second outer bulb end, which is still open. For this purpose, the available gas is sucked away by means of a pumping/flushing process through the second outer bulb end, and an inert filling gas, for example argon gas, is pumped into the intermediate space. During the pumping/flushing process, the second outer bulb end is fused with the discharge tube and, as a result, the discharge tube arrangement is sealed in a gas-tight manner. The input of heat required for heating the outer bulb ends takes place in each case via a gas burner. Finally, the second outer bulb end, which is required for the pumping/flushing process, is severed or trimmed.

Disadvantages associated with the abovedescribed solution are firstly that a complex pumping/flushing process is required for the gas exchange in the intermediate space and secondly that the trimming of the second outer bulb end causes additional complexity in terms of apparatus and waste glass. The waste glass produced results in an increased material requirement and thereby increases the production costs of the discharge tube arrangement. A further disadvantage is the fact that combustion gases from the gas burner, for example CO₂ and H₂O, can pass into the intermediate space before the second outer bulb end is sealed in a gas-tight manner. This makes it possible for H₂O to be deposited as condensate in the outer bulb once it has been sealed and cooled. This content of liquid in the outer bulb causes corrosion on the glass of the discharge tube arrangement and impairs the color locus stability and the luminous flux behavior over the life of the lamp.

### DESCRIPTION OF THE INVENTION

The invention is based on the object of providing a method for producing a discharge tube arrangement and a discharge tube arrangement, in which a simplified gas exchange in comparison with conventional solutions is made possible with reduced production complexity and defined gas filling.

This object is achieved as regards the method by the combination of features in claim 1 and as regards the discharge tube arrangement by the features of claim 17. Particularly advantageous embodiments of the invention are described in the dependent claims.

In the method according to the invention for producing a discharge tube arrangement for a lamp, a discharge tube is inserted into an outer bulb, the outer bulb being sealed off by the discharge tube, and an intermediate space for accommodating a gas filling being delimited by said discharge tube. According to the invention, flushing and subsequent filling of the intermediate space takes place via the discharge tube and not, as in the prior art according to DE 101 57 868 A1, via the outer bulb. As a result, no combustion gases remain in the intermediate space which are produced when the outer bulb is sealed or attached to the discharge tube. With the aid of the method according to the invention, any combustion gases arranged in the intermediate space which have passed into the intermediate space when the second outer bulb end was sealed can be removed in reliable fashion, and the intermediate space can be provided with a defined gas filling with the aid of the method according to the invention. In accordance with a particularly preferred variant of the method according to the invention, flushing of the intermediate space takes place via an outer bulb end, which is still open. This variant makes it possible to completely flush through the intermediate space since the flushing gas flows into the intermediate space from a first side via the discharge tube and emerges from the outer bulb on another side, with the result that, in contrast to conventional solutions, a complex pumping/flushing process can be dispensed with. Owing to the flushing-through during sealing of the second outer bulb end, furthermore no combustion gases from the gas burner can pass into the intermediate space. As a result, the intermediate space can be filled with a defined gas filling, in particular an inert gas, for example noble gas or nitrogen. A liquid deposit after sealing and cooling of the outer bulb with the disadvantages explained at the outset is prevented. The production of the discharge tube arrangement is likewise simplified in comparison with the generic method since the special working steps for severing the second outer bulb end can be dispensed with. As a result, unnecessary waste glass and the increased material requirement associated therewith are avoided.

It is particularly preferred if the flushing and filling of the intermediate space take place via a tubular section of the discharge tube and through a supply opening, which opens out into the tubular section, of the discharge tube. The supply opening is preferably introduced into the discharge tube as a drilled casing hole.

In an exemplary embodiment according to the invention, the supply opening is introduced into the discharge tube by means of a laser beam or other high-energy radiation.

Preferably, the discharge tube is arranged in the outer bulb in such a way that the supply opening is located within the outer bulb.

The outer bulb ends are deformed by means of a tool once they have been heated to a deformation temperature and are brought to bear against the discharge tube. As a result, the gas-tight intermediate space for accommodating the gas filling is formed.

In order to make a uniform input of heat possible during heating of the outer bulb ends, the outer bulb and/or the discharge tube is preferably rotated.

In a preferred exemplary embodiment, the outer bulb ends are rolled onto the discharge tube by means of a shaping roller. As a result, a gas-tight join of high quality is achieved between the outer bulb ends and the discharge tube.

In accordance with a particularly preferred exemplary embodiment of the invention, the supply opening and/or the tubular section is sealed in a gas-tight manner once the second outer bulb end has been sealed off.

It has proven to be particularly advantageous if the outer bulb is heated to a deformation temperature in the region of the supply opening and the supply opening is sealed by the outer bulb being pressed against it by means of a tool.

In a variant according to the invention, the outer bulb is heated to a deformation temperature in the region of the supply opening and the discharge tube is at least partially evacuated. Preferably, the heated region in this solution, owing to the pressure difference between the pressure of the gas filling and the ambient pressure, comes to bear against the supply opening and seals it in a gas-tight manner.

In an alternative variant, the discharge tube is heated to a deformation temperature and the tubular section of the discharge tube is sealed by means of the discharge tube being pinched and/or fused.

In a further exemplary embodiment of the invention, the supply opening is sealed by means of high-energy radiation, preferably by means of laser radiation, with or without the action of flushing gases.

The discharge tube arrangement according to the invention has an outer bulb into which a discharge tube is inserted, the outer bulb having two outer bulb ends, via which it is sealed off by the discharge tube, and an intermediate space, which is sealed in a gas-tight manner, for accommodating a gas filling is delimited by said discharge tube. According to the invention, the intermediate space is flushed via the discharge tube before the second outer bulb end is sealed off.

It has been shown that the gas filling preferably has a pressure in the range of from approximately 50 mbar to 1500 mbar after cooling of the lamp.

Preferably, the discharge tube has an axial drilled hole and a supply opening, which opens out into said drilled hole, for flushing and filling the intermediate space.

In a preferred exemplary embodiment, the supply opening is a drilled casing hole, which opens out into the tubular section of the discharge tube.

### BRIEF DESCRIPTION OF THE DRAWINGS

The invention will be explained in more detail below with reference to preferred exemplary embodiments. In the drawings:

FIG. 1 shows a longitudinal section through an exemplary embodiment according to the invention of a discharge tube arrangement;

FIG. 2 shows an enlarged illustration of the detail A from FIG. 1;

FIG. 3 shows a first method step for forming the discharge tube arrangement from FIG. 1;

FIG. 4 shows a second method step for forming the discharge tube arrangement from FIG. 1;

FIG. 5 shows a third method step for producing the discharge tube arrangement from FIG. 1;

FIG. 6 shows a further method step for producing the discharge tube arrangement from FIG. 1;

FIG. 7 shows a first method variant for sealing the drilled casing hole in a gas-tight manner by rolling;

FIG. 8 shows a second method variant for sealing the drilled casing hole by means of subatmospheric pressure;

FIG. 9 shows a third method variant for sealing the discharge tube by means of pinching;

FIG. 10 shows a further method variant for sealing the drilled casing hole by means of high-energy radiation, and

FIG. 11 shows flushing of the intermediate space via two drilled casing holes in the discharge arc tube.

### PREFERRED EMBODIMENTS OF THE INVENTION

The invention will be explained below with reference to a discharge tube arrangement for a discharge lamp with a base at one end, in particular for a metal-halide high-pressure discharge lamp for a motor vehicle headlamp. As has already been mentioned at the outset, the use of the method according to the invention is in no way restricted to such lamp types, however, but these lamp types are selected here merely by way of example.

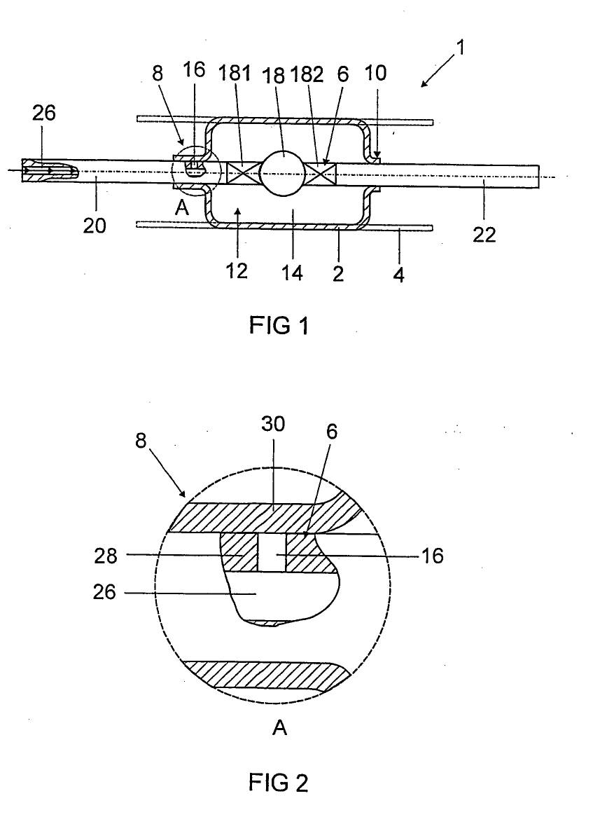

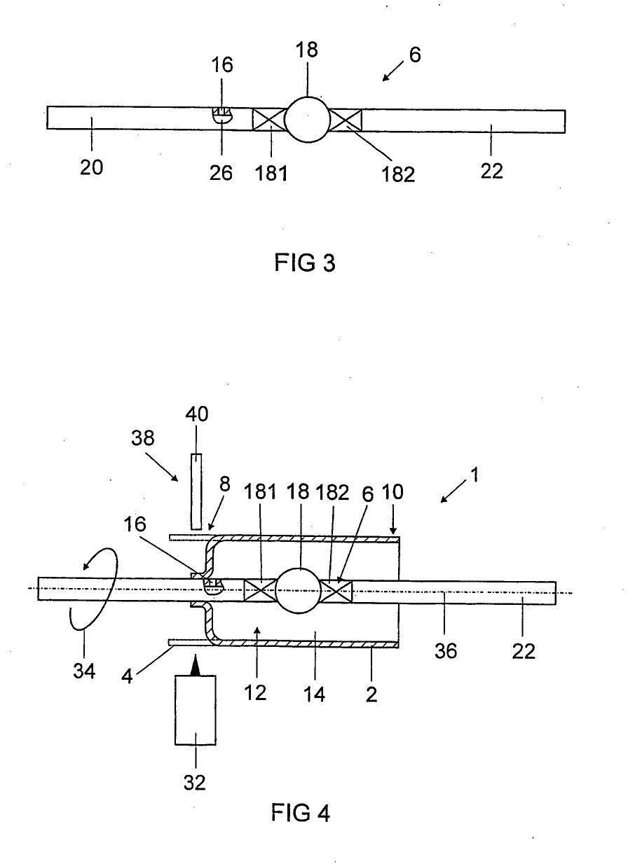

FIG. 1 shows a discharge tube arrangement 1 which can be used, for example, in a discharge lamp with a base at one end (not illustrated). The discharge tube arrangement 1 has an outer bulb 2, which, in the initial state (indicated by dashed lines), substantially has the shape of a hollow cylinder 4. A discharge tube 6 is inserted into the outer bulb 2 and is connected to the outer bulb 2 in a gas-tight manner via two outer bulb ends 8, 10 of said outer bulb 2. As a result, the outer bulb 2 with the discharge tube 6 delimits an intermediate space 12, which is sealed in a gas-tight manner, for accommodating a gas filling 14. In the exemplary embodiment illustrated, a discharge tube 6 is used which differs from the conventional design merely by a supply opening 16 in the region of the outer bulb 2, whose function will be explained in more detail in FIGS. 3 to 10. Such a discharge tube 6 substantially comprises a lamp vessel 18, which is sealed off at two ends by means of pinch seals 181, 182 and in whose interior an ionizable filling containing xenon and metal halides and two electrodes for producing a gas discharge are arranged and whose pinch seals 181, 182 merge with tubular holding sections 20, 22 at their outer ends. Power supply lines for in each case one of the abovementioned gas discharge electrodes run within the tubular holding sections 20, 22. The tubular holding sections 20, 22 are used for the connection to the outer bulb 2. According to the invention, flushing of the intermediate space 12 takes place via the discharge tube 6, i.e. via at least one of the tubular holding sections 20, 22 and at least one supply opening 16, which opens out into the tubular holding section 20, 22. The gas supply to the intermediate space 12 takes place via the interior 26 of the tubular holding section 20 and the supply opening 16.

As can be seen in particular in FIG. 2, which shows an enlarged illustration of the detail A from FIG. 1, the supply opening 16 is in the form of a drilled casing hole in a circumferential wall 28 of the discharge tube 6 and opens out radially into the interior 26 of the tubular holding section 20 of the discharge tube 6. The drilled casing hole 16 is introduced into the circumferential wall 28 of the discharge tube 6 by means of laser radiation, for example. In the exemplary embodiment shown, the drilled casing hole 16 is welded to a wall section 30 of the first outer bulb end 8 (on the left-hand side in FIG. 1) and is thereby sealed in a gas-tight manner.

The production of the discharge tube arrangement 1 will be explained below by way of example using the essential method steps with reference to FIGS. 3 to 10.

As shown in FIG. 3, which shows a detailed illustration of the discharge tube 6 from FIG. 1, in a first working step the radially running drilled casing hole 16 is introduced into the holding section 20 of the discharge tube 6 by means of laser radiation, for example.

As can be seen in FIG. 4, which shows a second method step for producing the discharge tube arrangement 1, the discharge tube 6 is then inserted into the outer bulb 2 in such a way that the drilled casing hole 16 of the discharge tube 6 is located within the outer bulb 2. Then, a first outer bulb end 8 is heated to deformation temperature. The heating to deformation temperature takes place in the solution illustrated by a gas burner 32 (indicated schematically), via which the region of the outer bulb end 8 is heated. It is furthermore possible to carry out the heating by means of high-energy radiation, for example by means of laser radiation. In order to make a uniform input of heat possible, the outer bulb 2 and the discharge tube 6 are rotated about a longitudinal axis 36 of the discharge tube arrangement 1 during the heating, as is indicated by an arrow 34. After heating of the first outer bulb end 8 to a deformation temperature, this outer bulb end is deformed out of the initial state (indicated by dashed lines) by means of a tool and is thereby brought to bear against the discharge tube 6. For example, a shaping roller 40 (indicated schematically) can be used as the tool 38, via which shaping roller the first outer bulb end 8 is rolled onto the discharge tube 6 in the region of the holding section 20 and is welded to said discharge tube. This makes a gas-tight connection to the discharge tube 6 possible.

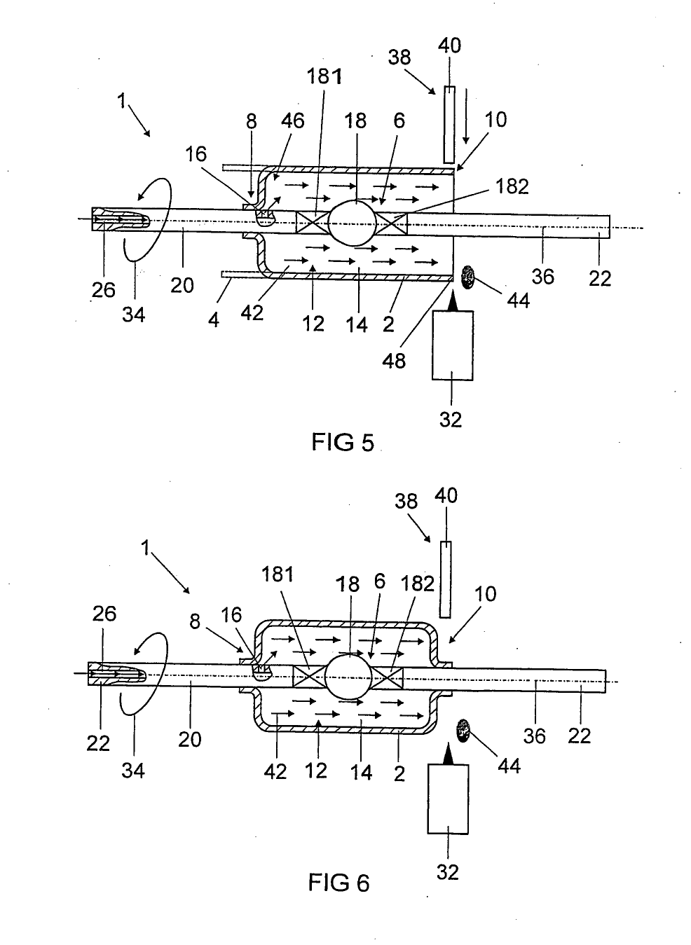

As can be seen in FIG. 5, the second outer bulb end 10 (on the right-hand side in FIG. 5), which is still open, is heated to deformation temperature by means of the gas burner 32 in the following method step. The heating and welding of the second outer bulb end 10 to the discharge tube 6 is carried out substantially as explained already in FIG. 4. According to the invention, flushing of the intermediate space 12 via the discharge tube 6 takes place before the second outer bulb end 10 is sealed off and before the subsequent gas filling. For this purpose, flushing gas 42 is introduced into the axial drilled hole 26 of the discharge tube 6 and enters the approximately annular intermediate space 12, which is delimited by the outer bulb 2 and the discharge tube 6, via the drilled casing hole 16. Since the flushing gas 42 flows into the intermediate space 12 via the discharge tube 6, i.e. via the tubular holding section 20 and the drilled casing hole 16, and can emerge from the outer bulb 2 again on the other side owing to the second outer bulb end 10 which is open, the intermediate space 12 is flushed through completely and a defined gas exchange is carried out, with the result that, in contrast to conventional solutions, a complex pumping/flushing process can be dispensed with.

Owing to the flushing-through during sealing of the second outer bulb end 10, furthermore no combustion gases 44 (indicated schematically) from the gas burner 32 can pass into the intermediate space 12. As a result, the intermediate space 12 can be filled with a defined flushing gas filling 14. The flushing-through is further improved by the introduction of the flushing gas 42 into the outer, bulb 2 into an intermediate space section 46 (on the left-hand side in FIG. 5), which is remote from the open second outer bulb end 10. An inert gas, for example a noble gas, nitrogen or the like is used as the flushing gas 42. Owing to the use of an inert gas 42, a liquid deposit after sealing and cooling of the outer bulb—with the disadvantages explained at the outset—and the oxidation of the molybdenum power supply line (not illustrated), which is arranged in the interior 26 of the tubular holding section 20 of the discharge tube 6, are prevented. The production of the discharge tube arrangement 1 is likewise simplified in comparison with the prior art according to DE 101 57 868 A1 since the special working steps for severing the second outer bulb end 10 can be dispensed with since the welding can take place at an edge region 48 of the outer bulb end 10 owing to the flushing-through.

Once the second outer bulb end 10 has been heated to a deformation temperature, as shown in FIG. 6 it is brought to bear against the discharge tube 6 by means of the shaping roller 40, is rolled onto said discharge tube and is welded there. As a result, the second outer bulb end 10 is connected in a gas-tight manner to the discharge tube 6.

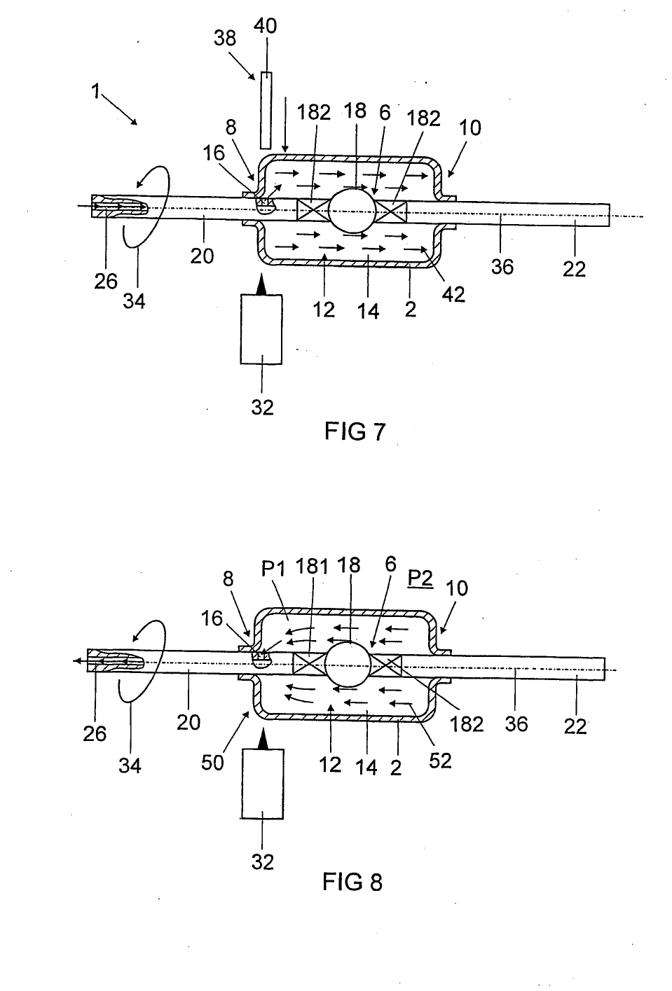

In the following method step, the annular intermediate space 12, which is delimited by the discharge tube and the outer bulb, is sealed off hermetically. For this purpose, the drilled casing hole 16 or the tubular holding section 20 is sealed in a gas-tight manner. This will be explained in more detail with reference to FIGS. 7 to 10.

As shown in FIG. 7, which shows a first method variant for sealing the drilled casing hole 16, the outer bulb 2 is once again heated to a deformation temperature in the region of the drilled casing hole 16 via the gas burner 32 and, as can be seen in particular in FIG. 2, the drilled casing hole 16 is sealed by the outer bulb 2 being pressed against it in the direction of the arrow by means of the shaping roller 40 (so-called subsequent rolling). That is to say the drilled casing hole 16 is sealed via the wall section 30 of the first outer bulb end 8 and is welded to it. As a result, the intermediate space 12, which is filled with flushing gas 42, is sealed off in a gas-tight manner.

As an alternative to the abovedescribed method step, the drilled casing hole 16 can be sealed by means of subatmospheric pressure, as shown in FIG. 8. For this purpose, the outer bulb 2 is heated to a deformation temperature in a region 50 of the drilled casing hole 16, and the discharge tube 6, i.e. the tubular holding section 20 and the drilled casing hole 16, is at least partially evacuated (indicated by arrow 52 in FIG. 8). Owing to the pressure difference between the pressure of the gas filling P1 and the ambient pressure P2 (P1<P2), the heated region 50 of the first outer bulb end 8 comes to bear against the drilled casing hole 16 and seals it in a gas-tight manner (see FIG. 2).

As shown in FIG. 9, which shows a further variant of a method step for sealing the intermediate space 12 in a gas-tight manner, the discharge tube 6 is heated to a deformation temperature by means of the gas burner 32 in the region of the holding section 20 in a discharge tube region 54, which is not covered by the first outer bulb end 8, and is sealed by means of pinching and/or fusing. The pinching 56 takes place via shaping and pinching jaws 58, with the result that the once cylindrical holding section 20 of the discharge tube 6 is pressed closed. By means of pinching the discharge tube 6 together, the tubular holding section 20 and therefore the intermediate space 12 is sealed in a gas-tight manner. In order to improve the sealing, shapings, for example flattening or stamping, can be carried out on the power supply line consisting of molybdenum wire. Alternatively, the sealing can be carried out by means of a further molybdenum foil glass composite as in the pinch seals 181, 182 close to the burner. As a further alternative, the sealing can be realized in this region by means of glass solder or by means of transition glasses, which bridge the difference in the coefficients of expansion of quartz glass and metal and therefore make improved glass fusing and sealing possible.

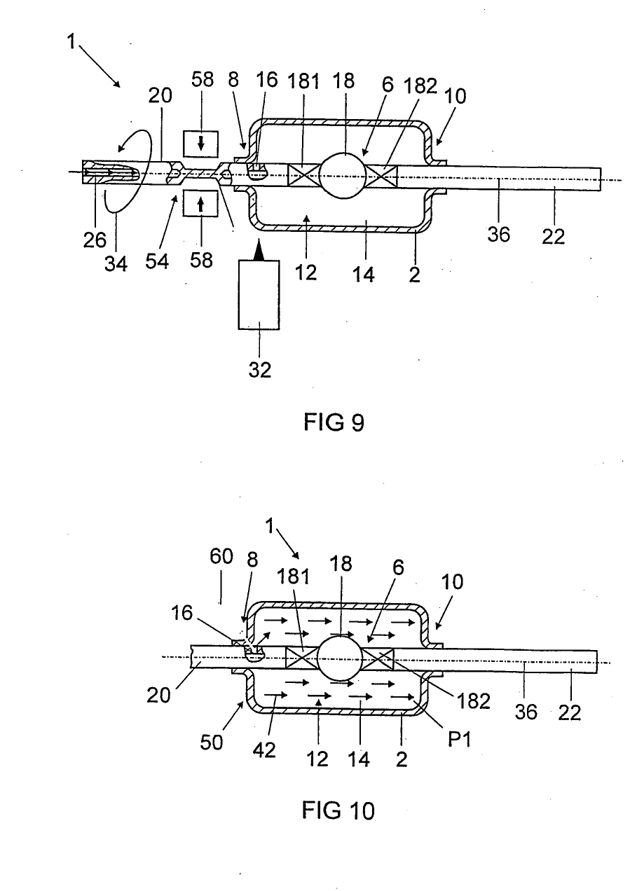

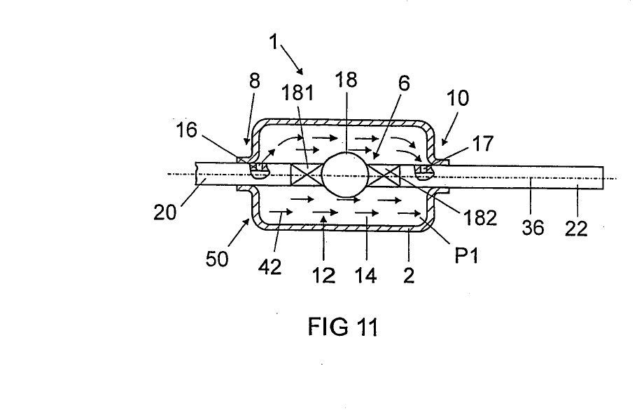

FIG. 10 shows a further method variant for sealing the drilled casing hole 16 of the discharge tube 6 in accordance with which the drilled casing hole 16 is sealed by means of high-energy radiation. For this purpose, in the exemplary embodiment shown a laser beam 60 is used which passes through the outer bulb 2 from the outside and acts on the drilled casing hole 16. The laser radiation results in heating in the region of the drilled casing hole 16 and, as a result, in fusing of its circumferential wall 28 (see FIG. 2). The fusing can also be influenced by the inflow or outflow of the flushing gases 42.

After targeted cooling of the discharge tube arrangement 1, the gas filling 14 has a pressure in the range of from approximately 50 mbar to 1500 mbar, for example, in the intermediate space 12.

Naturally, the drilled casing hole 16 can also be arranged in the opposite holding section 22 (see FIG. 1) of the discharge tube 6. It is essential that the drilled casing hole 16 is located within the outer bulb 2. In this variant, the second outer bulb end 10 (on the right-hand side in FIG. 1) is welded to the discharge tube 6 before the first outer bulb end 8 is sealed. Finally, the drilled casing hole 16 or the discharge tube 6 is sealed in a gas-tight manner in accordance with one of the method steps explained in FIGS. 7 to 10.

Alternatively, the intermediate space 12 can also be flushed via the two tubular holding sections 20 and 22 and via supply openings 16 and 17 arranged therein. The flushing gas flow in this case passes through the first tubular holding section 20 and the supply opening 16 into the intermediate space 12 and then via a further supply opening 17, which is fitted within the intermediate space 12 in the second tubular holding section 22, through the second tubular holding section 22. The flushing gas therefore flows through the two tubular holding sections 20, 22 and the intermediate space 12, past the sealed-off lamp vessel 18. This variant has the advantage that the outer bulb 2 can be fitted on the discharge tube 6 and sealed before it is flushed and filled with gas, and nevertheless complete flushing of the intermediate space 12 is possible. Filling of the intermediate space 12 and sealing of the supply openings 16, 17 take place in the same way as in the other exemplary embodiment.

The discharge tube arrangement 1 according to the invention is not restricted to the described heating and welding by means of the gas burner 32 and shaping rollers 40, but instead any connection technique known from the prior art can be used which makes it possible to seal the outer bulb 2 with the discharge tube 6 in a gas-tight manner.

The invention discloses a method for producing a discharge tube arrangement 1 for a lamp and a discharge tube arrangement 1 produced in accordance with such a method. This discharge tube arrangement 1 has an outer bulb 2 into which a discharge tube 6 is inserted, the outer bulb 2 being sealed off by the discharge tube 6, and an intermediate space 12, which is sealed in a gas-tight manner, for accommodating a gas filling 14 is delimited by said discharge tube 6. According to the invention, flushing and/or filling of the intermediate space 12 with gas takes place via the discharge tube 6.

### LIST OF REFERENCE SYMBOLS

1 Discharge tube arrangement
2 Outer bulb
4 Hollow cylinder
6 Discharge tube
8 First outer bulb end
10 Second outer bulb end
12 Intermediate space
14 Gas filling
16 Supply opening (drilled casing hole)
17 Supply opening (drilled casing hole)
18 Lamp vessel
181 Pinch seal of lamp vessel 18
182 Pinch seal of lamp vessel 18
20 Holding section
22 Holding section
26 Interior of tubular holding section 20
28 Circumferential wall
30 Wall section
32 Gas burner
34 Arrow
36 Longitudinal axis
38 Tool
40 Shaping roller
42 Flushing gas
44 Combustion gases
46 Intermediate space section
48 Edge region
50 Region
52 Arrow
54 Discharge tube region
56 Pinching
58 Shaping and pinching jaws
60 Laser beam
42 Flushing gas
44 Combustion gases
46 Intermediate space section
48 Edge region
50 Region
52 Arrow
54 Discharge tube region
56 Pinching
58 Shaping and pinching jaws
60 Laser beam

1. A method for producing a discharge tube arrangement (1) for a lamp, having an outer bulb (2) into which a discharge tube (6) is inserted, the outer bulb (2) being sealed off by the discharge tube (6), and an intermediate space (12), which is sealed in a gas-tight manner, for accommodating a gas filling (14) is delimited by said discharge tube (6), characterized in that flushing and/or filling of the intermediate space (12) with gas takes place via the discharge tube (6).

2. The method as claimed in claim 1, flushing and filling of the intermediate space (12) taking place via at least one tubular section (20) of the discharge tube (6) and through at least one supply opening (16), which opens out into the tubular section (20).

3. The method as claimed in claim 2, flushing taking place via an open outer bulb end (10).

4. The method as claimed in claim 2, flushing taking place via two supply openings (16, 17), which are each fitted in a tubular section (20, 22) of the discharge tube (6) and are located within the outer bulb (2).

5. The method as claimed in claim 1, the discharge tube (6) being arranged in the outer bulb (2) in such a way that the at least one supply opening (16) of the discharge tube (6) is located within the outer bulb (2).

6. The method as claimed in claim 2, the at least one supply opening (16) being introduced into the discharge tube (6) as a drilled casing hole.

7. The method as claimed in claim 6, the at least one supply opening (16) being introduced into the discharge tube (6) by means of high-energy radiation, preferably by means of laser radiation.

8. The method as claimed in claim 1, the outer bulb ends (8, 10) being deformed by means of a tool (38) once they have been heated to a deformation temperature and being brought to bear against the discharge tube (6).

9. The method as claimed in claim 8, the outer bulb (2) and/or the discharge tube (6) being rotated during heating.

10. The method as claimed in claim 8, the outer bulb ends (8, 10) being rolled onto the discharge tube (6) by means of a shaping roller (40).

11. The method as claimed in claim 2, the supply opening (16) and/or the tubular section (20) being sealed in a gas-tight manner once the second outer bulb end (10) has been sealed off.

12. The method as claimed in claim 11, the outer bulb (2) being heated to a deformation temperature in the region of the at least one supply opening (16), and the at least one supply opening (16) being sealed by the outer bulb (2) being pressed against it by means of a tool (38).

13. The method as claimed in claim 11, the outer bulb (2) being heated to a deformation temperature in the region of the at least one supply opening (16), and the discharge tube (6) being at least partially evacuated.

14. The method as claimed in claim 13, the heated region (50), owing to the pressure difference between the pressure (P1) of the gas filling (14) and the ambient pressure (P2), coming to bear against the at least one supply opening (16) and sealing it.

15. The method as claimed in claim 11, the discharge tube (6) being heated to a deformation temperature, and the tubular section (20) being sealed by means of the discharge tube (6) being pinched and/or fused.

16. The method as claimed in claim 11, the at least one supply opening (16) being sealed by means of high-energy radiation (60), preferably by means of laser radiation, with or without the action of the flushing gases (42).

17. A discharge tube arrangement for a lamp, having an outer bulb (2) into which a discharge tube (6) is inserted, the outer bulb (2) being arranged on the discharge tube (6), and an intermediate space (12), which is sealed in a gas-tight manner, for accommodating a gas filling (14) being delimited by said discharge tube, characterized in that the intermediate space (12) is flushed and/or filled with gas via the discharge tube (6).

18. The discharge tube arrangement as claimed in claim 17, the discharge tube (6) having at least one tubular section (20) and a supply opening (16), which opens out into said section, for flushing and filling the intermediate space (12).

19. The discharge tube arrangement as claimed in claim 18, the at least one supply opening (16) being a drilled casing hole and opening out into the tubular section (20).

20. The discharge tube arrangement as claimed in claim 17, the gas filling (14) having a pressure in the range of from 50 mbar to 1500 mbar.
